(19) United States
(12) Patent Application Publication
(10) Pub. No.: US 2018/0003152 A1
(43) Pub. Date: Jan. 4, 2018

(54) Wind turbine with rotational air guides

(71) Applicants: Waldemar Piskorz, Koden (PL); Tomasz Tadeusz Piskorz, Koden (PL); Ireneusz Piskorz, Koden (PL)

(72) Inventors: Waldemar Piskorz, Koden (PL); Tomasz Tadeusz Piskorz, Koden (PL); Ireneusz Piskorz, Koden (PL)

(21) Appl. No.: 15/545,840

(22) PCT Filed: Jan. 22, 2016
(86) PCT No.: PCT/IB2016/050330

§ 371 Date: Jul. 24, 2017

(30) Foreign Application Priority Data
Jan. 22, 2015 (PL) P.411022

(51) Int. Cl. F03D 3/04; F03D 9/34

(52) U.S. Cl. CPC F03D 3/0409; F03D 3/0427; F03D 9/34; F05B 2240/21

(57) ABSTRACT

Wind turbine according to the invention has at least one movable guide consisting of two rectangular wings (14) and (15) set in one plane and fixed with one edge to mounted shaft (11) set parallel to the axis of the turbine (2) and in such way that the edge of the first wing (14) is tangential, with small space, to the edge of the bar (10) which is an extension of the guide vane (4) of the body (3) and is set in the same plane as guide vane (4), where the edge of the first wing (14) rests on resilient members (16) fixed to the bar (10), and spread of the second wing (15) is smaller than the spread of the first wing (14) and the shaft (11) is connected to drive mechanism (13) equipped with positional switch, where the drive mechanism (13) is connected to control system.

The subject of the invention is a wind turbine with rotary guides, and wind turbine with double rotary guides.

A device supporting a column combined of wind turbines is known from Polish invention P-409601, which has masts set together from pipe sections connected by flanges, equipped with at least one elastic wing, with one edge fixed to the rotably set roller on the side of the column. The second, parallel edge of the wing is connected with a tightener, both ends of which connected with rods of pneumatic cylinders, attached immovably to the mast. The edge of the mast, with rods of the first pneumatic cylinders at maximum extension, is tangential to the guide vane of the opposite segment of the column.

According to the invention there is at least one rotary guide next to a wind turbine, said rotary guide comprises two rectangular wings set in one plane and fixed with one edge to mounted shaft, mounted at the base. The wings are set on the same height as the wind turbine. The shaft is set parallel to the axis of the wind turbine. The edge of the first wing is tangential, with small space, to the bar which is an extension of a guide vane of the turbine body and is set in the same plane as said guide vane. The edge of the first wing is based on resilient members fixed to said bar. The span of the first wing is smaller than the span of the first wing. Said shaft is connected to drive mechanism equipped with positional switch, and the drive mechanism is connected to a control system.

There is at least one clamp mounted on said shaft, which is fixed to a cover of the body of the turbine with a truss.

Alternatively the resilient members are fixed slidingly with control system.

The invention also relates to the device with double rotary guides.

According to the invention, next to a turbine there is at least one rotable, double guide, consisting of first shaft with at least one pair of two rectangular wings, fixed with one edge to first shaft and second shaft with at least one pair of another two wings, where both said shafts are mounted at the base. First wing and second wing, connected to the first shaft on the same height, are set in the same plane. Third wing and fourth wing are fixed with one edge to the second shaft on the same height as first and second wing, a furthermore third wing and forth wing are set in the same plane. Axes of the first shaft and the second shaft are parallel to the axis of the turbine. The first shaft is situated in such way, that the loose edge of the first wing, at a position closest to the axis of the turbine, is tangent, with small space, to the edge of the bar which is an extension of the guide vane of the turbines body, and at the same time both wings of the first shaft are in the same plane as said guide vane. Edge of the first wing is captured by movable latches fixed on said bar and connected to control system. Span of the second wing is smaller than the span of the first wing. End edge of the loose end of the second wing is reflexed according to wind direction, and is made from supple material. The first shaft is coupled with the first drive mechanism equipped with positional switch and connected with control system.

The second shaft is situated in relation to the first shaft in such a way that loose end of the third wing, while it is in a position closes to the first shaft, rests on the reflexed end edge of the second wing, and in the same time the surfaces of the third wing and the fourth wing are in the same plane as the first and the second wing. Favorably span of the third wing is bigger than the span of the first wing, and the span of the fourth wing is smaller than the span of the second wing. The second shaft is set rotably and coupled with second drive mechanism, equipped with positional switch. The second drive mechanism is connected with control system.

There is at least one clamp mounted on the first shaft, and on the second shaft there is at least one sleeve mounted, set in pairs on the same heights. The clamp is rigidly fixed to a cover of the body of the turbine with a truss, and said sleeve is rigidly fixed to the clamp with connector.

Wind turbine with support device set under the right angle in relation to wind direction, can achieve significantly higher power while maintaining technically and economically reasonable size. Additionally, the turbine equipped with this device is set into rotation even with little wind.

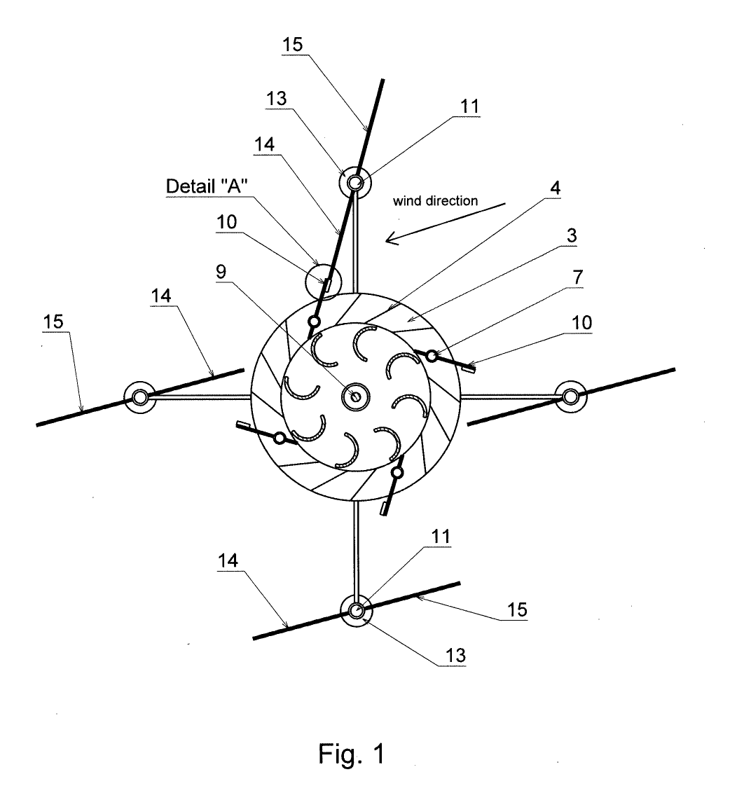

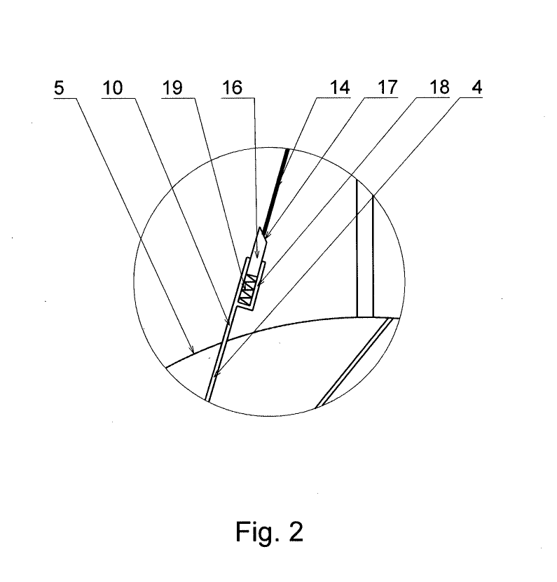

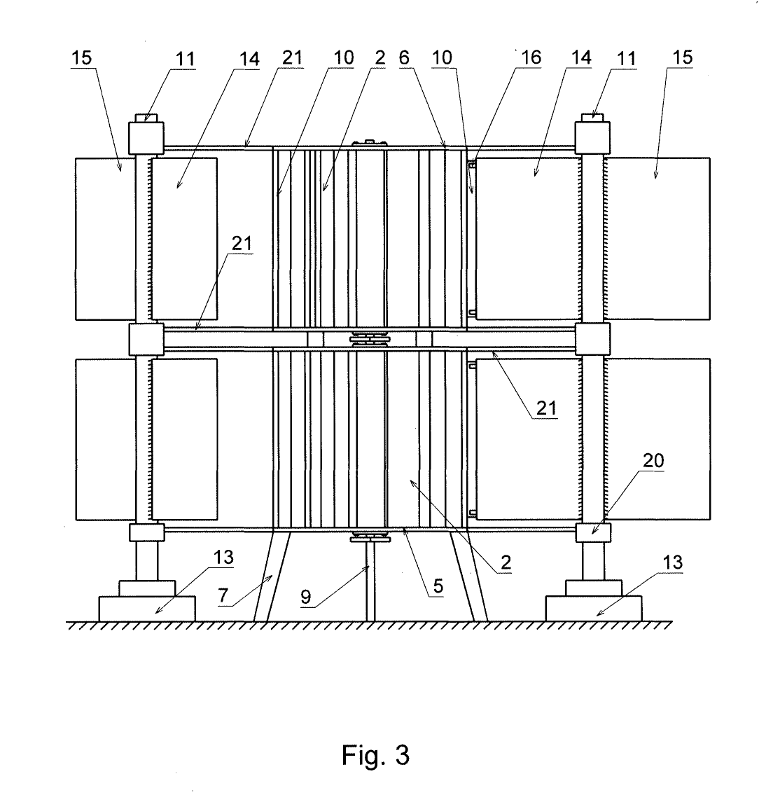

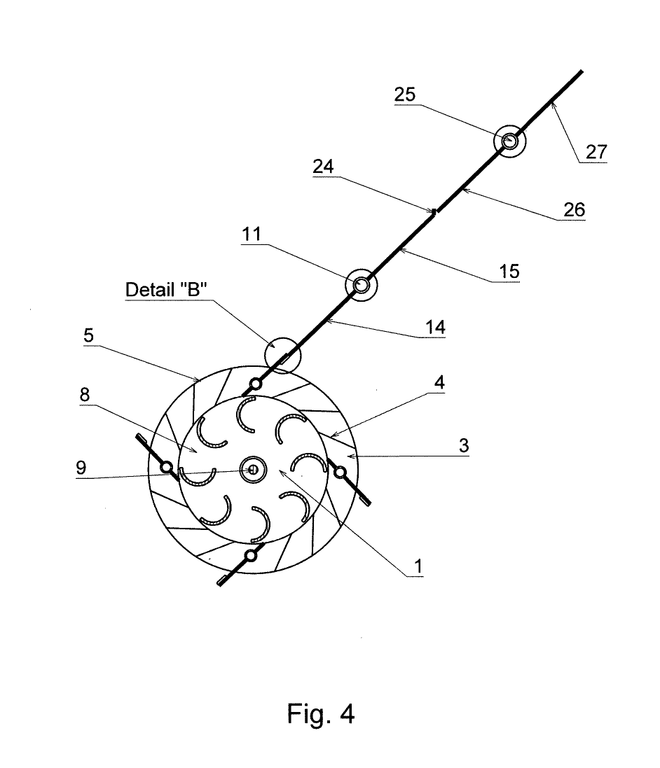

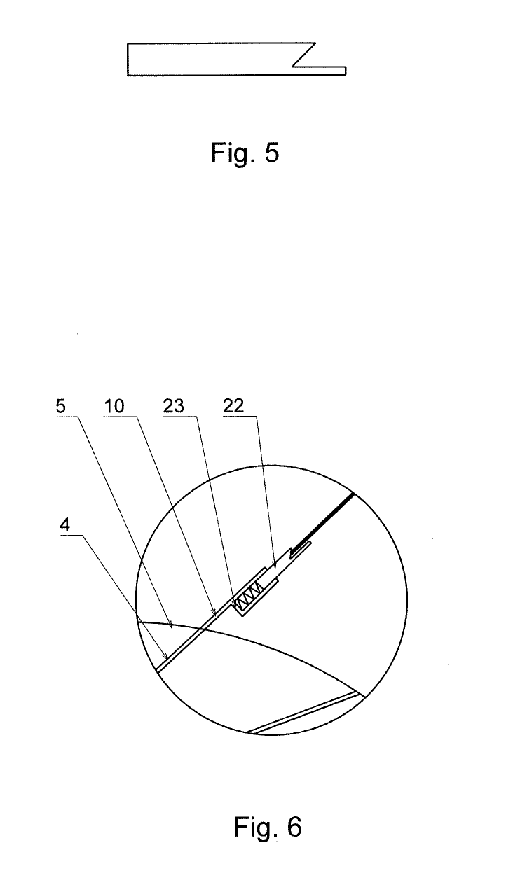

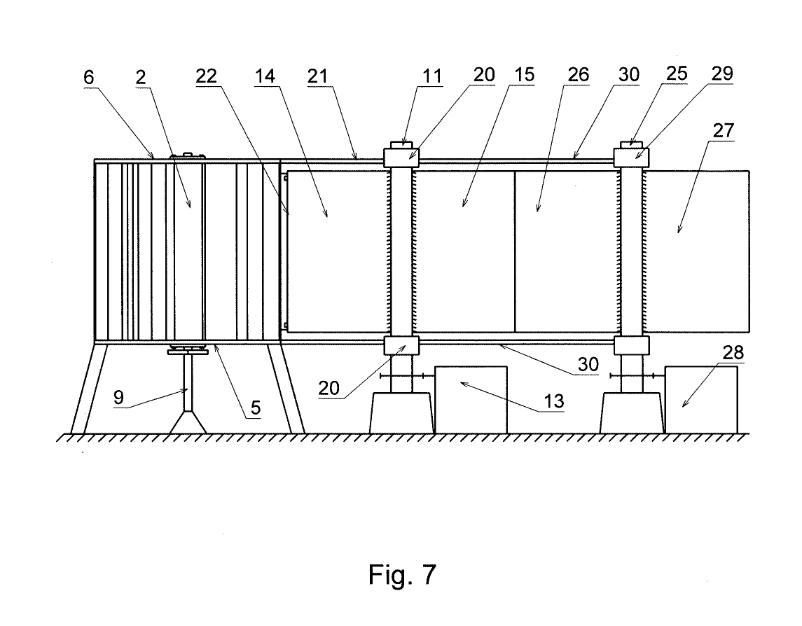

The example of the invention is shown on drawings, where FIG. 1 shows schematic cross-section of the turbine with four guides, FIG. 2 shows a detail of the connection of the first wing with an resilient member (detail “A”), FIG. 3 shows simplified view of the turbine with guides set in one plane with the bar and guide vane of the body of the turbine, FIG. 4 shows schematic cross-section of the turbine with double guide, FIG. 5 shows view of the latch, FIG. 6 shows a detail of the connection of the first wing with the latch (detail “B”), and FIG. 7 shows schematic overview of the turbine with double guides.

### EXAMPLE I

Wind column 1 consist of two turbines 2. Each turbine 2 has a body 3 with guide vanes 4 fixed to covers 5 and 6, which are connected with segment supports 7, fixed to the foundation. In the body 3 there is a rotor 8 situated on the pole 9, also fixed in the foundation. There is a bar 10 welded to four guides vanes 4 set every 90°, said bar 10 being extension of each of said guide vanes 4. There are four shafts 11 set in bearings around the column 1, said shafts are coupled with drive mechanisms 13. On each of the shafts 11 there are wings 14 and 15 fixed in pairs with one edge, set in one plane. Wings 14 and 15, set on the same height, are made of composite material. First wing 14 has bigger spread than wing 15. Shafts 11 are set in such a way that the edge of the first wing 14, when in position closest to the column 1, is tangential, with small space, to the bar 10, and at the same time, wings 14 and 15 are set in one plane with said bar 10. The edge of the first wing 14, in this position, rests on resilient members 16 fixed to the bar 10. Member 16 is in a form of a pin ended with oblique head 17 and is placed slidingly in a guideway 18, and its face rests on spring 19. Alternatively, resilient members 16, set slidingly, are controlled by a control system, not shown on the drawing. Drive mechanisms 13 are also coupled with control system.

The edge of the first wings 14 is tangential of the bar 10 only on the shaft 11 the wings 14 and 15 of which are directed effectively to the wind direction, that is when surfaces of the wings 14 and 15 of such shaft 11 are set in the angle greater than 45°. Surfaces of the wings 14 and 15 of the remaining shafts 11 are set in parallel to the wing direction. On each shaft 11 between pairs of wings 14 and 15 there are clamps 20 mounted connected with trusses 21 with covers 5 and 6.

Depending on the direction of the wind, one of the drive mechanisms 13 rotates a shaft connected to it to a position where the edges of two first wings 14 of this shaft 11 are tangential to bars 10 and at the same time are resting on the resilient members 16. Surfaces of the wings 14 and 15 of the remaining shafts 11 are set freely in parallel to the wing direction. The wings 14 and 15 of one of the shaft 11 positioned in such way direct more air to rotors 8. When the speed of the wind exceeds set boundary value, first wings 14 press the resilient members 16, that are adjusted accordingly. Alternatively members 16 are released by the signal from control system. When this happens, the shaft 11 rotates freely, and the wings 14 and 15 position themselves so that their surface is parallel to the direction of the wind. After the wing speed reduces, or its direction changes, on the signal from the sensor located on the wind column 1 one of the drive mechanisms 13 rotates the shaft 11 coupled with it to position, where edges of first wings 14 are tangential to bars 10. At that point, the additional flow of air is again directed to rotors 8.

### EXAMPLE II

Wind column 1 consist of one turbine 2. Turbine 2 has a body 3 with guide vanes 4 fixed to covers 5 and 6, which are connected with segment supports 7, fixed to the foundation. In the body 3 there is a rotor 8 situated on the pole 9, also fixed in the foundation. There is a bar 10 welded to one of the guides vanes 4, said bar 10 being extension of said guide vane 4. Next to a turbine 2 there is a first shaft 11 mounted rotably with axis parallel to pole 9, coupled with first drive mechanism 13 which is equipped with positional switch. On the shaft 11 there are wings 14 and 15 fixed in pairs with one edge, set in one plane. Wings 14 and 15, are made of composite material. First wing 14 has bigger spread than wing 15. The first shaft 11 is set in such a way that the edge of the first wing 14, when in position closest to the column 1, is tangential, with small space, to the bar 10, and at the same time, wings 14 and 15 are set in one plane with said bar 10. The edge of the first wing 14, in this position is between unequal latch 22 arms, said arms being fixed slidably to the bar. Latches 22 are coupled with electromagnet 23, connected to the control system. Drive mechanism 13 is also coupled with control system. On the shaft 11 there are two clamps 20 mounted connected by trusses 21 with covers 5 and 6 that stiffen the structure. End, vertical edge 24 of the loose end of the second wing 15 is reflexed according to wind direction. The structure of the second guide consists of second shaft 25, that has third wing 26 and fourth wing 27 fixed with one edge to the shaft 25 and set in one plane. Wings 25 and 26 are made from composite material. Second shaft 25 is parallel to first shaft 11. Second shaft 25 is set in relation to first shaft 11 in such way, that the edge of the third wing 26 is rested on the elastic edge 24 of the second wing 15. Spread of the fourth wing 27 is smaller than the spread of the third wing 26. Second shaft 25 is mounted rotably and coupled with second drive mechanism 28 equipped with a positional switch, where the second drive mechanism 28 is coupled with control system.

On the second shaft 25 there are sleeves 29 mounted, said sleeves 29 are connected to said clamps 20 with connectors 30.

In case of advantageous wind direction drive mechanism 13 rotates the shaft 11 connected to it to position in which the edge of the first wing 14 of said shaft 11 is tangential to the bar 10 and at the same way the edge is captured by the fork of latch 22. Then the second drive mechanism 28 rotates the second shaft 25 to a position where the edge of the third wing rests on the elastic edge 24 of the second wing 14. Wings 14, 15, 26 and 27 direct additional air to rotor 8. When the speed of the wind exceeds set boundary value, the third wing 26 bends the edge 24 and the second shaft 25 rotates under the wind to position where wings 26 and 27 put the lowest resistance. Next the latch 22 releases the first wing 14. When this happens, the shaft 11 rotates freely, and the wings 14 and 15 position themselves so that their surface is parallel to the direction of the wind. After the speed of wind reduces, on the signal from sensor installed on the turbine, drive mechanism 13 rotates the shaft 11 to start position, and then the second drive mechanism 28 rotates second shaft 25.

1. A wind turbine having stationary body with guide vanes fixed to covers of the cylinder, within which a rotor is mounted, characterized in that it has at least one movable guide, said guide consist of two rectangular wings (14) and (15) set in one plane and fixed with one edge to mounted shaft (11) set parallel to the axis (2) of the turbine and in such way that the edge of the first wing (14) is tangential, with small space, to the edge of the bar (10), which is an extension of the guide vane (4) of the body (3) and is set in the same plane as guide vane (4), wherein the edge of the first wing (14) is rested on resilient members (16) fixed to the bar (10), and spread of the second wing (15) is smaller than the spread of the first wing (14) and the shaft (11) is connected to drive mechanism (13) equipped with positional switch, where the drive mechanism (13) is connected to control system.

2. The wind turbine according to claim 1, characterized in that on the shaft (11) there is at least one clamp (20) mounted, which is connected to cover (5) or (6) of the body (3) with truss (21)

3. The wind turbine according to claim 1, characterized in that the edge of the first wing (14) rests on resilient members (16) fixed slidingly to the bar (10) and connected to the control system.

4. A wind turbine having stationary body with guide vanes fixed to covers of the cylinder, within which a rotor is mounted, characterized in that it has at least one rotational double guide, which comprises of a first shaft (11) with at least one pair of rectangular wings (14) and (15), fixed with one edge to the shaft (11) and a second shaft (25) with at least one pair of rectangular wings (26) and (27), where said rectangular wings (14) and (15), as well as wings (26) and (27) are fixed in pairs in one plane, where axes of the shafts (11) and (25) are parallel to the axis (2) of the turbine, where the first shaft (11) is set in such way that the edge of the first wing (14) fixed to the first shaft (11) when positioned closest to the turbine axis (2) is tangential, with small space to the edge of the bar (10), which is an extension of the guide vane (4) of the body (3), where the edge of the wing (14) is captured by latches (22) fixed slidingly to bar (10), and spread of the second wing (15) is smaller than the spread of the first wing (14), and loose edge (24) of the second wing (15) is reflexed according to wind direction, and the second shaft (25) is situated in relation to the firs shaft (11) in such way that the edge of the third (26) rests on the reflexed edge (24) of the second wing (15), and spread of the fourth wing (27) is smaller than the spread of the third wing (26), and the first shaft (11) and the second shaft (25) are mounted rotably, where the first shaft (11) is coupled with a first drive mechanism (13) and the second shaft (25) is coupled with a second drive mechanism (28), where said drive mechanisms (13) and (28) and latches (22) are connected to a control system.

5. The wind turbine according to claim 4, characterized in that on the first shaft (11) there is at least one clamp (20) mounted, and on the second shaft (25) there is at least one sleeve (29) mounted, where the clamp on one side is fixed to a cover (5) or (6) of the body (3) of the turbine (2) with a truss (21), and on the other side clamp (20) is connected with sleeve (29) with a connector (30).

6. The wind turbine according to claim 4, characterized in that the edge (24) of the second wing (15) is made of resilient material.
